(19) United States
(12) Patent Application Publication
(10) Pub. No.: US 2026/0129492 A1
(43) Pub. Date: May 7, 2026

(54) CONTROL DEVICE, COMMUNICATION DEVICE, COMMUNICATION SYSTEM, OPERATION METHOD, AND STORAGE MEDIUM

(71) Applicant: HONDA MOTOR CO., LTD., Tokyo (JP)

(72) Inventor: Yoshihiko NAKAGAWA, Tokyo (JP)

(21) Appl. No.: 19/355,514

(22) Filed: Oct. 10, 2025

(30) Foreign Application Priority Data
Nov. 7, 2024 (JP) 2024-195259

(51) Int. Cl. H04W 24/10; H04W 4/48; H04W 48/08

(52) U.S. Cl. CPC H04W 24/10; H04W 4/48; H04W 48/08

(57) ABSTRACT

A control device mounted on a vehicle, the control device comprising: a communication unit configured to perform either first communication using a first communication scheme or second communication using a second communication scheme, the second communication scheme being different from the first communication scheme; a detection unit configured to detect a communication state of the first communication; an acquisition unit configured to acquire device information of a communication device present either in an inside of the vehicle or in surroundings of the vehicle; and a determination unit configured to determine whether to switch from the first communication to the second communication via the communication device, based on the device information, in a case where the detection unit detects that the first communication is in a first communication state while the first communication is being performed.

### CROSS-REFERENCE TO RELATED APPLICATION(S)

This application claims priority to and the benefit of Japanese Patent Application No. 2024-195259, filed Nov. 7, 2024, the entire disclosure of which is incorporated herein by reference.

### BACKGROUND OF THE INVENTION

### Field of the Invention

The present invention relates to a control device, a communication device, a communication system, an operation method, and a storage medium.

### Description of the Related Art

Japanese Patent Laid-Open No. 2021-132301 discloses determining a communication priority in accordance with communication used by a vehicle.

However, in the technique described in Japanese Patent Laid-Open No. 2021-132301, mobile communication is enabled by a contract between a vehicle and a communication carrier. However, there are places with good communication quality and places with poor communication quality for every communication carrier. For this reason, there is a problem that the communication quality changes while the vehicle is traveling and the vehicle communication environment becomes unstable.

### SUMMARY OF THE INVENTION

The present invention has been made in view of the above problem, and provides a technique for achieving a good vehicle communication environment.

According to one aspect of the present invention, there is provided a control device mounted on a vehicle, the control device comprising: a communication unit configured to perform either first communication using a first communication scheme or second communication using a second communication scheme, the second communication scheme being different from the first communication scheme; a detection unit configured to detect a communication state of the first communication; an acquisition unit configured to acquire device information of a communication device present either in an inside of the vehicle or in surroundings of the vehicle; and a determination unit configured to determine whether to switch from the first communication to the second communication via the communication device, based on the device information, in a case where the detection unit detects that the first communication is in a first communication state while the first communication is being performed.

### BRIEF DESCRIPTION OF THE DRAWINGS

FIG. 1 is a block diagram of a vehicle and a control device according to one embodiment;

FIG. 2 is a diagram illustrating an example of a functional configuration of the control device according to one embodiment;

FIG. 3 is a flowchart illustrating a procedure of processing performed by a control device according to a first embodiment;

FIG. 4 is a flowchart illustrating a procedure of processing performed by a control device according to a second embodiment;

FIG. 5 is a diagram illustrating an example of a hardware configuration of a communication device according to the second embodiment;

FIG. 6 is a block diagram illustrating an example of a functional configuration of the communication device according to the second embodiment; and

FIG. 7 is a flowchart illustrating a procedure of processing performed by the communication device according to the second embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

In the present embodiment, description will be made with regard to an example in which in a communication system including a vehicle and a communication device (such as a smartphone) that communicates with the vehicle, in a case where a communication state of cellular communication degrades while cellular communication used by the vehicle is being performed, whether to switch from the cellular communication to tethering communication via the communication device is determined, based on device information of the communication device.

### Control Device and its Application Example

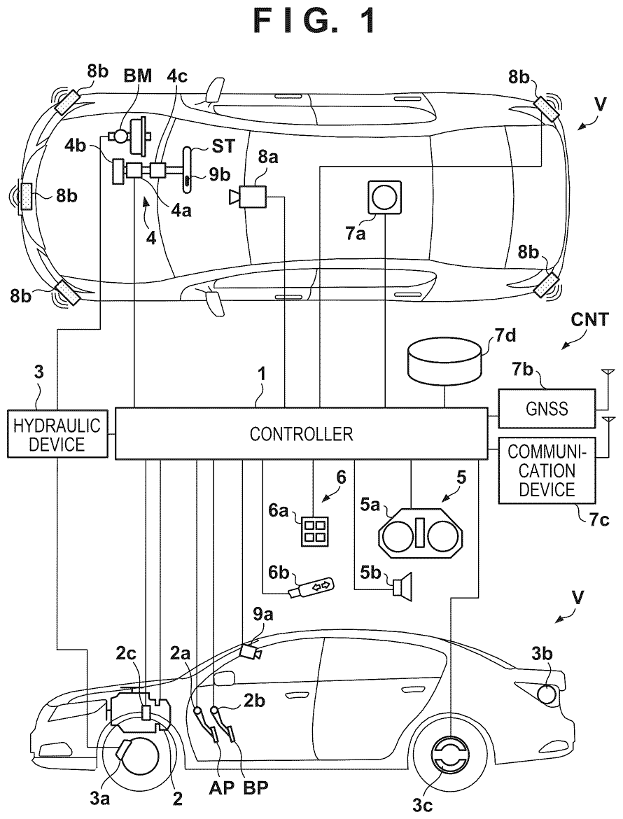

FIG. 1 is a block diagram of a control device CNT according to one embodiment of the present invention, and is also a schematic diagram of a vehicle V, which is an application example of the control device CNT. In FIG. 1, an outline of the vehicle V is illustrated in a plan view and a side view. The vehicle V according to the present embodiment is, for example, a sedan-type four-wheeled passenger vehicle, and may be, for example, a parallel hybrid vehicle. Note that the vehicle V is not limited to the four-wheeled passenger vehicle, and may be a straddle type vehicle (a motorcycle or a three-wheeled vehicle) or a large-sized vehicle such as a truck or a bus.

The control device CNT includes a controller 1, which is an electronic circuit that conducts control of the vehicle V, including driving assistance of the vehicle V. The controller 1 includes a plurality of electronic control units (ECUs). For example, an ECU is provided for every function of the control device CNT. Each ECU includes a processor represented by a central processing unit (CPU), a storage device such as a semiconductor memory, an interface with an external device, and the like. The storage device stores a program to be executed by the processor, data used for processing on the processor, and the like. The interface includes an input and output interface and a communication interface. Each ECU may include a plurality of processors, a plurality of storage devices, and a plurality of interfaces. A program to be stored in the storage device may be installed in the control device CNT using a storage medium such as a CD-ROM, and thus may be stored in the storage device.

The controller 1 controls driving (acceleration) of the vehicle V by controlling a power unit (a power plant) 2. The power unit 2 is a travel driving unit that outputs driving force for rotating drive wheels of the vehicle V, and can include an internal combustion engine, a motor, and an automatic transmission. The motor can be used as a driving source for accelerating the vehicle V, and can also be used as a generator at the time of deceleration or the like (regenerative braking).

In the present embodiment, the controller 1 controls the outputs of the internal combustion engine and the motor and switching of the gear ratio of the automatic transmission in response to driver's driving operation that has been detected by an operation sensor 2a, which is provided in an accelerator pedal AP, and by an operation sensor 2b, which is provided in a brake pedal BP, and in accordance with a speed of the vehicle V that has been detected by a rotation speed sensor 2c. Note that as a sensor for detecting a traveling state of the vehicle V, the rotation speed sensor 2c, which detects the rotation speed of an output shaft of the automatic transmission, is provided on the automatic transmission. The vehicle speed of the vehicle V can be calculated from a detection result of the rotation speed sensor 2c.

The controller 1 controls braking (deceleration) of the vehicle V by controlling a hydraulic device 3. The driver's brake operation on the brake pedal BP is converted into hydraulic pressure in a brake master cylinder BM, and is transmitted to the hydraulic device 3. The hydraulic device 3 is an actuator capable of controlling the hydraulic pressure of hydraulic oil supplied to a brake device 3a (for example, a disc brake device) provided on each of the wheels, based on the hydraulic pressure transmitted from the brake master cylinder BM.

The controller 1 is capable of controlling braking of the vehicle V by conducting drive control of an electromagnetic valve or the like included in the hydraulic device 3. In addition, the controller 1 is also capable of configuring an electric servo brake system, by controlling the distribution of the braking force by the brake device 3a and the braking force by the regenerative braking of the motor included in the power unit 2. The controller 1 may turn on a brake lamp 3b at the time of braking.

The controller 1 controls steering of the vehicle V by controlling an electric power steering device 4. The electric power steering device 4 includes a mechanism for steering front wheels in response to the driver's driving operation (steering operation) on a steering wheel ST. The electric power steering device 4 includes a drive unit 4a, which exerts driving force (referred to as steering assist torque, in some cases) for assisting the steering operation or automatic steering of the front wheels of the vehicle V. The drive unit 4a includes a motor as a drive source. In addition, the electric power steering device 4 further includes a steering angle sensor 4b, which detects a steering angle, and a torque sensor 4c, which detects steering torque (also, referred to as steering load torque to be distinguished from steering assist torque) applied by the driver.

The controller 1 controls an electric parking brake device 3c, which is provided for the rear wheels of the vehicle V. The electric parking brake device 3c includes a mechanism for locking the rear wheels. The controller 1 is capable of controlling locking and unlocking of the rear wheels by the electric parking brake device 3c.

The controller 1 controls an information output device 5, which notifies the inside of the vehicle of information. The information output device 5 includes, for example, a display device 5a, which notifies the driver of information with an image, and/or a sound output device 5b, which notifies the driver of information with sound. Examples of the display device 5a include a display device provided on an instrument panel and a display device provided on the steering wheel ST. In addition, the display device 5a may include a head-up display. The information output device 5 may notify the occupant of information using vibration or light. In addition, a plurality of display devices 5a may be provided, and each of the display devices 5a may be disposed at a position corresponding to each seat (for example, in front of each seat). This enables information to be notified to occupants of the vehicle V other than the driver.

The controller 1 receives an instruction input from the occupant (for example, the driver) via an input device 6. The input device 6 is disposed at a position operable by the driver, and includes, for example, a switch group 6a, which is used for the driver to instruct the vehicle V, and/or a blinker lever 6b, which actuates a direction indicator (a blinker).

The controller 1 recognizes and determines a current position and a course (an attitude) of the vehicle V. In the present embodiment, a gyro sensor 7a, a global navigation satellite system (GNSS) sensor 7b, and a communication device 7c are provided in the vehicle V. The gyro sensor 7a detects a rotational motion (a yaw rate) of the vehicle V. The GNSS sensor 7b detects the current location of the vehicle V. In addition, the communication device 7c wirelessly communicates with a server for providing map information and traffic information, and acquires such pieces of information. In the present embodiment, the controller 1 determines the course of the vehicle V, based on detection results of the gyro sensor 7a and the GNSS sensor 7b, also acquires map information about the course from the server sequentially via the communication device 7c, and then stores the map information in a database 7d (a storage device). Note that another sensor for detecting the state of the vehicle V, such as an acceleration sensor for detecting the acceleration of the vehicle V, may be provided in the vehicle V.

The controller 1 performs the driving assistance of the vehicle V, based on detection results of various detection units provided in the vehicle V. The vehicle V includes: a plurality of surroundings detection units 8a and 8b, each of which is an external sensor for detecting the outside (a surrounding situation) of the vehicle V; and a plurality of in-vehicle detection units 9a and 9b, each of which is an in-vehicle sensor for detecting a situation inside the vehicle (the states of occupants, particularly, the driver). The controller 1 is capable of grasping the surrounding situations of the vehicle V, based on the detection results of the surroundings detection units 8a and 8b, and then performing the driving assistance in accordance with the surrounding situations. In addition, the controller 1 is capable of determining whether the driver is performing a predetermined operation obligation imposed on the driver, when conducting the driving assistance, based on the detection results of the in-vehicle detection units 9a and 9b.

The surroundings detection unit 8a is an imaging device (hereinafter, referred to as a front camera 8a, in some cases) that captures an image on a forward side of the vehicle V, and is attached to the interior side of the vehicle of a windshield in a roof front part of the vehicle V, for example. By analyzing an image captured by the front camera 8a, the controller 1 is capable of extracting a contour of a target object or a lane division line (such as a white line) on a road.

The surroundings detection unit 8b is a millimeter wave radar (hereinafter, referred to as a radar 8b, in some cases), detects a target object in the surroundings of the vehicle V using radio waves, and detects (measures) a distance to the target object and a direction (an azimuth) of the target object with respect to the vehicle V. In the example illustrated in FIG. 1, five radars 8b are provided, including one at the center of the front portion of the vehicle V, one at each of the left and right corner portions of the front portion, and one at each of the left and right corner portions of the rear portion.

Note that the surroundings detection unit provided in the vehicle V is not limited to the above configuration, and the number of cameras and the number of radars may be changed, or a light detection and ranging (LiDAR) for detecting a target object in the surroundings of the vehicle V may be provided.

The in-vehicle detection unit 9a is an imaging device (hereinafter, referred to as an in-vehicle camera 9a, in some cases) that captures an image of the inside of the vehicle, and is attached to, for example, the inside of the vehicle in the roof front part of the vehicle V. In the present embodiment, the in-vehicle camera 9a is a driver monitor camera that captures an image of the driver (for example, driver's eye and face). By analyzing an image (an image of the driver's face) that has been captured by the in-vehicle camera 9a, the controller 1 is capable of recognizing the driver and determining a driver's line of sight and the orientation of a driver's face. Further, the in-vehicle camera 9a may include a plurality of in-vehicle cameras, each of which is provided at a position corresponding to each seat. The images captured by the respective in-vehicle cameras are analyzed, so that the occupant in the front passenger seat and the occupant in the rear passenger seat may be recognized, or their directions of the line of sight or the orientations of their faces may be determined.

The in-vehicle detection unit 9b is a grip sensor (hereinafter, referred to as a grip sensor 9b, in some cases) that detects the driver's grip on the steering wheel ST, and is provided in at least a part of the steering wheel ST, for example. Note that as the in-vehicle detection unit, the torque sensor 4c, which detects the steering torque of the driver, may be used.

### Functional Configuration

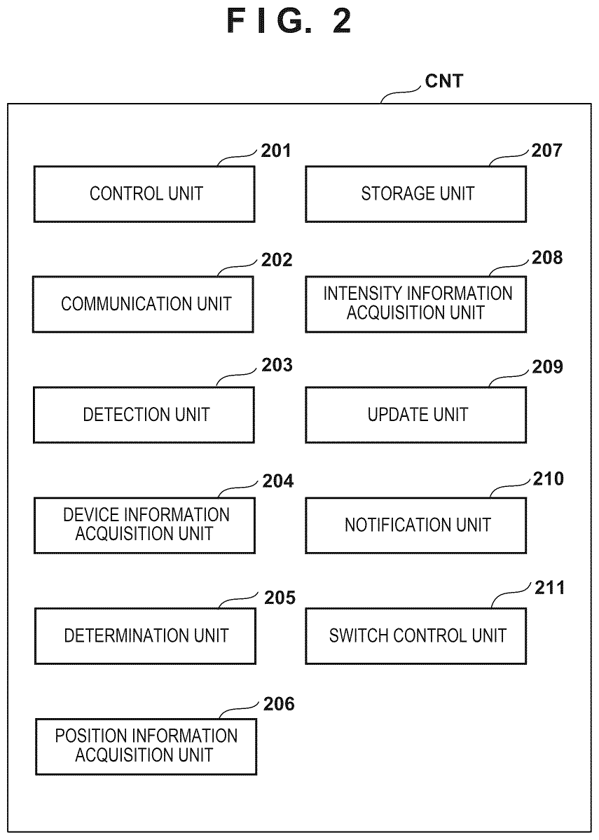

An example of a functional configuration of the control device according to the present embodiment will be described with reference to FIG. 2. The function of each processing unit included in the control device according to the present embodiment is achieved by one or more ECUs or CPUs reading and executing a program stored in a storage device.

The control device CNT is mounted on the vehicle V. The control device CNT includes a control unit 201, a communication unit 202, a detection unit 203, a device information acquisition unit 204, a determination unit 205, a position information acquisition unit 206, a storage unit 207, an intensity information acquisition unit 208, an update unit 209, a notification unit 210, and a switch control unit 211. However, in the present embodiment, all the processing units are not necessarily essential.

The control unit 201 controls the entire operation of the control device CNT.

The communication unit 202 is capable of performing, via the communication device 7c, first communication using a first communication scheme or second communication using a second communication scheme, which is different from the first communication scheme. Here, the first communication using the first communication scheme is, for example, cellular communication using a cellular communication scheme used by the vehicle V, and the second communication using the second communication scheme is tethering communication using a tethering communication scheme, but there is no limitation to them. By performing the tethering communication, the vehicle V is connected with another communication device (for example, a smartphone), and is capable of performing the Internet connection using the data communication function of another communication device (the smartphone). As the tethering communication, here, for example, Wi-Fi tethering communication, Bluetooth (registered trademark) tethering communication, or USB tethering communication can be used.

The detection unit 203 detects a communication state of the first communication using the first communication scheme (for example, the cellular communication using the cellular communication scheme used by the vehicle V).

The device information acquisition unit 204 acquires device information of a communication device (a smartphone, a tablet terminal, or the like) present inside the vehicle V or in the surroundings of the vehicle V. The device information can include at least one of information indicating the communication state of the communication device, information indicating a type of an access point with which the communication device is communicating in the first communication scheme (for example, the cellular communication scheme), owner information of the communication device, and communication cost information of the communication device. The type of the access point is, for example, a communication carrier such as DoCoMo, KDDI, Softbank, or Rakuten Mobile. The communication cost information can include, for example, information indicating whether an additional cost is incurred in performing the tethering communication, information indicating the amount of cost in a case where the additional cost is incurred, information indicating a remaining communication capacity that is available without an additional cost, or the like.

In a case where the detection unit 203 detects that the first communication is in a first communication state (a communication state is worse than a predetermined standard, communication intensity is equal to or lower than predetermined intensity, or the like) while the first communication (for example, the cellular communication of the vehicle V) is being performed, the determination unit 205 determines whether to switch from the first communication (for example, the cellular communication of the vehicle V) to the second communication (the tethering communication) via the communication device, based on the device information of the communication device.

The position information acquisition unit 206 acquires position information of the vehicle V using, for example, the GNSS sensor 7b.

The storage unit 207 stores, as communication intensity information, the communication intensity of every access point in association with an area. For example, for every area, X denoting the communication intensity of the communication service provided by the first communication carrier, Y denoting the communication intensity of the communication service provided by the second communication carrier, Z denoting the communication intensity of the communication service provided by the third communication carrier, and for example, X>Y>Z being established are stored as known information.

The intensity information acquisition unit 208 acquires communication intensity information from a server apparatus (not illustrated) that manages the communication intensity information. Here, the communication intensity information that the server apparatus has acquired from each communication carrier is collectively managed, and is acquired from the server apparatus.

The update unit 209 is capable of updating the communication intensity information stored in the storage unit 207, based on an acquisition result of the intensity information acquisition unit 208. The update may be periodically conducted, or may be conducted in response to acceptance of an update instruction from the user. In addition, the update unit 209 is capable of updating the communication intensity information stored in the storage unit 207, based on a detection result of the detection unit 203. From the result detected by the control device CNT, by updating with use of the actual communication intensity of the first communication (for example, the cellular communication used by the vehicle V) in the area where the vehicle V is located, it becomes possible to collect more precise information corresponding to the actual situation.

In a case where the determination unit 205 determines switching from the first communication to the second communication, the notification unit 210 gives notification before the switching. The notification unit 210 may give the notification, in a case where the owner of the communication device is different from the owner of the vehicle V. In addition, the notification unit 210 may give the notification, in a case of recognizing that an additional cost is incurred in performing the second communication, based on the communication cost information.

The notification unit 210 may give the notification to the communication device, or may give the notification using the display device 5a, which is included in the vehicle V. This enables the notification given to the user of the communication device, the user riding in the vehicle V.

In a case where the determination unit 205 determines switching from the first communication to the second communication, the switch control unit 211 switches the communication. In such a situation, in a case where the notification unit 210 gives the notification, the communication may be switched in a case of receiving an instruction to agree on the switching from the occupant (the user) who has received the notification or in response to acceptance of an instruction input.

### Processing

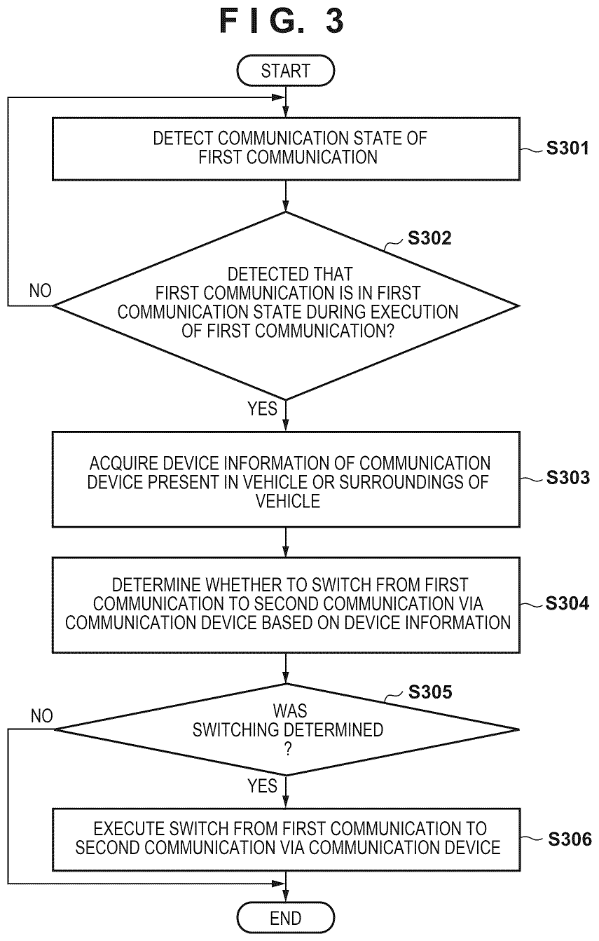

Subsequently, a procedure of processing performed by the control device according to the present embodiment will be described with reference to a flowchart of FIG. 3. In S301, the detection unit 203 detects the communication state (a good or poor situation of radio waves, for example, radio wave intensity) of the first communication (the cellular communication) using the first communication scheme (for example, the cellular communication scheme) used by the vehicle V.

In S302, the control unit 201 determines whether the detection unit 203 has detected that the first communication is in the first communication state (a situation in which the communication state is worse than a predetermined standard, a situation in which the communication intensity is equal to or lower than predetermined intensity, or the like) while the first communication is being performed. In a case where the determination in this step is Yes, the processing proceeds to S303. On the other hand, in a case where the determination in this step is No, the processing returns to S301.

In step S303, the device information acquisition unit 204 acquires the device information of a communication device (for example, a smartphone, a tablet terminal, or the like) present inside the vehicle V or in the surroundings of the vehicle V.

In S304, the determination unit 205 determines whether to switch from the first communication to the second communication (the tethering communication) using the second communication scheme, which is different from the first communication scheme, via the communication device, based on the device information acquired by the device information acquisition unit 204. For example, the device information can include information indicating a communication state of the communication device. The determination unit 205 may determine switching from the first communication to the second communication, in a case where the communication device is in a second communication state (a state in which the communication state is better than the predetermined standard, a state in which the communication intensity is higher than the predetermined intensity, or a state in which the communication state is better than the first communication state). In addition, the device information can include information indicating a type (for example, a communication carrier) of an access point with which the communication device is communicating in the first communication scheme. The determination unit 205 may determine switching from the first communication to the second communication, in a case where such a type is different from the type of the access point with which the control device CNT is communicating in the first communication scheme.

In S305, the control unit 201 determines whether the determination unit 205 has determined switching from the first communication to the second communication. In a case where the determination in this step is Yes, the processing proceeds to S306. On the other hand, in a case where the determination in this step is No, the processing ends.

In S306, the switch control unit 211 switches from the first communication to the second communication via the communication device. The processing of FIG. 3 has been described heretofore.

As described heretofore, in the present embodiment, in a case where the communication state of the first communication degrades while the first communication (the cellular communication) used by the vehicle V is being performed, whether to switch from the first communication to the second communication (the tethering communication) via the communication device is determined, based on the device information (the information indicating a communication state of the communication device or the type of access point with which communication device is performing the cellular communication) of the communication device (a smartphone).

Accordingly, even in a case where the communication state with an external access point used by the vehicle degrades, it becomes possible to reduce degradation of the communication state in the vehicle by switching to the communication (the tethering communication) via the communication device (the smartphone), based on the device information. Therefore, a good vehicle communication environment is achievable.

### Modifications

In the above-described embodiment, the description has been made with regard to an example of switching from the first communication (the cellular communication) to the second communication (the tethering communication), and then ending the processing, but there is no limitation to this example. For example, after that, in a case where the detection unit 203 further detects the communication state of the second communication, and detects that the second communication is in the first communication state (the situation in which the communication state is worse than the predetermined standard, the situation in which the communication intensity is equal to or lower than the predetermined intensity, or the like) while the second communication is being performed, the determination unit 205 may further determine whether to switch from the second communication to the first communication. In such a situation, the communication state of the first communication may be detected again, and in a case where the communication state of the first communication is better than the communication state of the second communication, switching from the second communication to the first communication may be determined.

In addition, in the above-described embodiment, as an example in S304, the description has been made with regard to switching from the first communication to the second communication, in a case where the type (for example, the communication carrier) of the access point with which the communication device is communicating in the first communication scheme is different from the type of the access point with which the control device CNT is communicating in the first communication scheme, but there is no limitation to this example. For example, the position information acquisition unit 206 may acquire the position information of the vehicle V, and the communication intensity of every access point may be stored in association with the area, as the communication intensity information, in the storage unit 207.

In this situation, the determination unit 205 may determine switching from the first communication to the second communication, in a case where the type of the access point with which the communication device is communicating in the first communication scheme is different from the type of the access point with which the control device CNT is communicating in the first communication scheme, and in a case where the communication intensity of the access point with which the communication device is communicating in the first communication scheme in the area where the vehicle V is located is equal to or higher than the predetermined intensity. For example, in a case where the first communication carrier is used by the vehicle V, the second communication carrier is used by the communication device (a smartphone), and in a case where the communication intensity of the second communication carrier is good in the area where the vehicle V is located, switching may be determined. Alternatively, in the area where the vehicle V is located, in a case where the communication intensity of the second communication carrier is higher than that of the first communication carrier, switching may be determined.

Furthermore, as in the above modification, in the case where the storage unit 207 stores the communication intensity of every access point in association with the area, as the communication intensity information, the update unit 209 may update the communication intensity information, based on a detection result (the communication state of the first communication) of the detection unit 203. Accordingly, it becomes possible to reflect the communication intensity information corresponding to the actual situation, so that accuracy of the communication intensity information stored in the storage unit 207 can be improved.

In addition, instead of the control device CNT acquiring and updating the latest communication state information, another server apparatus may be configured to collect and update the information so as to provide the control device CNT with the latest communication state information. For example, the intensity information acquisition unit 208 may acquire the communication intensity information from a server apparatus (not illustrated) that manages the communication intensity information, and the update unit 209 may update the communication intensity information stored in the storage unit 207, based on an acquisition result of the intensity information acquisition unit 208.

### Second Embodiment

In the present embodiment, description will be made with regard to an example of giving notification before switching from the first communication to the second communication. Since the device configuration is similar to the configuration described in FIGS. 1 and 2, its description will be omitted.

### Processing

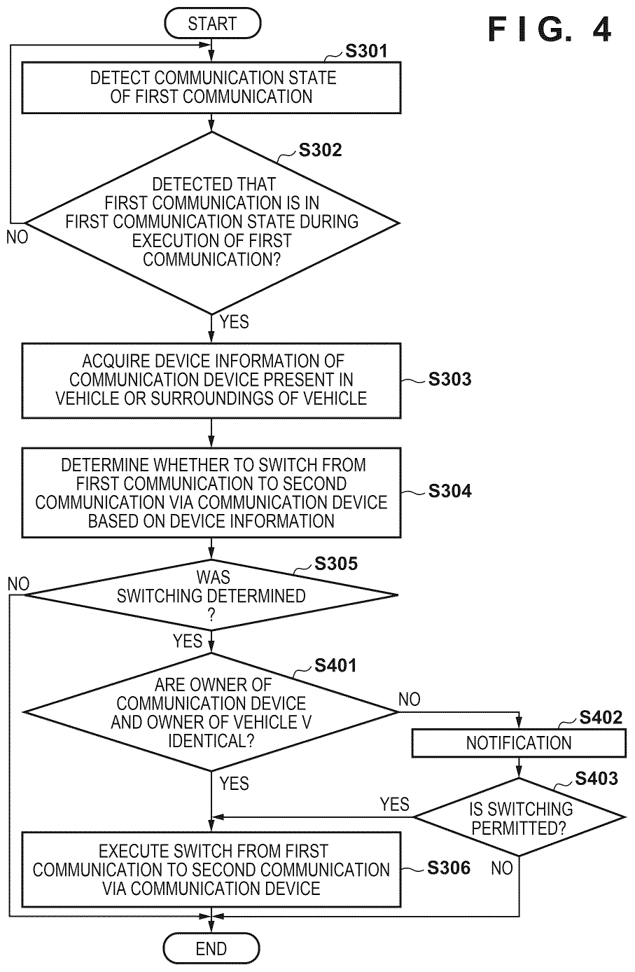

A procedure of processing performed by the control device CNT according to the present embodiment will be described with reference to FIG. 4. Processing similar to that in FIG. 3 is designated by an identical step number, and its description will be omitted. In the present embodiment, the device information further includes owner information of a communication device.

In S401, the control unit 201 determines whether the owner of the communication device is identical to the owner of the vehicle V, based on the owner information of the communication device included in the device information. In a case where the determination in this step is Yes, the processing proceeds to S306. On the other hand, in a case where the determination in this step is No, the processing proceeds to S402.

In S402, the notification unit 210 gives notification indicating switching from the first communication to the second communication. Such notification includes information for inquiring whether to permit or deny switching. The notification may be given to the communication device (a smartphone), or may be given with use of the display device 5a of the vehicle V. In a case of giving the notification to the communication device (the smartphone), the notification unit 210 may give the notification by transmitting, to the communication device, notification information for inquiring about either permission or denial of performing the second communication (the tethering communication) using the second communication scheme.

In S403, the control unit 201 determines whether switching is permitted by the user of the communication device. For example, in a case of receiving information indicating that switching is permitted from the communication device, it is possible to determine that switching is permitted. In a case of receiving information indicating that switching is denied from the communication device, it is possible to determine that switching is denied. Alternatively, in a case where the notification is given with use of the display device 5a of the vehicle V, the input device 6 may be operated to accept an input of information indicating permission or denial. In addition, in a case where the display device 5a is a touch panel display, selection of an icon indicating permission or denial may be accepted by accepting a touch input. In a case where the determination in this step is Yes, the processing proceeds to S306. On the other hand, in a case where the determination in this step is No, the processing ends.

### Operation of Communication Device

Subsequently, the operation of the communication device that communicates with the vehicle V according to the present embodiment will be described.

### Hardware Configuration of Communication Device

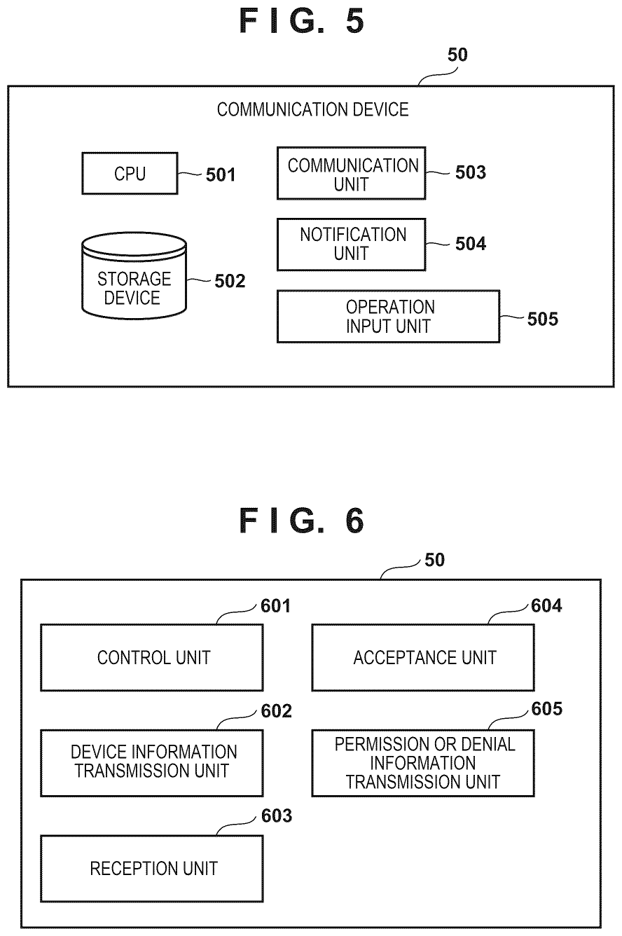

First, an example of a hardware configuration of the communication device according to the present embodiment will be described with reference to FIG. 5. As illustrated in FIG. 5, a communication device 50 includes a CPU 501, a storage device 502, a communication unit 503, a notification unit 504, and an operation input unit 505. A control operation of the communication device 50 is achieved by the CPU 501 reading and executing a computer program stored in the storage device 502. The CPU 501 may include one or more CPUs. The storage device 502 includes one or more memories that store various types of information. For example, information that has been received from another apparatus, a computer program to be read and executed by the CPU 501, and the like are stored. The communication unit 503 has a function of communicating with another device on wired or wireless communication through a network. In addition, the communication unit 503 is also capable of communicating with a nearby device on the tethering communication using Wi-Fi connection, Bluetooth (registered trademark) connection, USB connection, or the like.

The notification unit 504 may be a speaker, a display, a vibrator, or the like, and gives notification using at least one of sound, display, and vibration.

Any one of the sound, display, and vibration may be used, or two or more of them may be used in combination. The operation input unit 505 is, for example, a mouse, a keyboard, a touch panel, a switch, or the like, and is capable of receiving input of various types of information from a user.

### Functional Configuration of Communication Device

Next, an example of a functional configuration of the communication device according to the present embodiment will be described with reference to FIG. 6. The function of each processing unit included in the communication device according to the present embodiment is achieved by the CPU 501 reading and executing a program stored in the storage device 502. The communication device 50 is, for example, a smartphone, a tablet terminal, or the like, and includes a control unit 601, a device information transmission unit 602, a reception unit 603, an acceptance unit 604, and a permission or denial information transmission unit 605.

The control unit 601 controls the operation of the entirety of the communication device 50. The device information transmission unit 602 transmits the device information of the communication device 50 to the vehicle V in response to a request from the vehicle V. The reception unit 603 receives an acquisition request for acquiring the device information of the communication device 50 from the vehicle V. In addition, the reception unit 603 receives, from the vehicle V, notification indicating switching from the first communication using the first communication scheme (the cellular communication scheme) used by the vehicle to the second communication using the second communication scheme (the tethering communication scheme) via the communication device 50. The acceptance unit 604 accepts an input of information indicating permission or denial of switching from the user in accordance with the notification received from the vehicle V. For example, a selection icon for permission or denial may be displayed while the contents of the switching notification are being displayed, and a selection from the user may be accepted. The permission or denial information transmission unit 605 transmits information indicating permission or denial that has been accepted by the acceptance unit 604 to the vehicle V.

### Processing of Communication Device

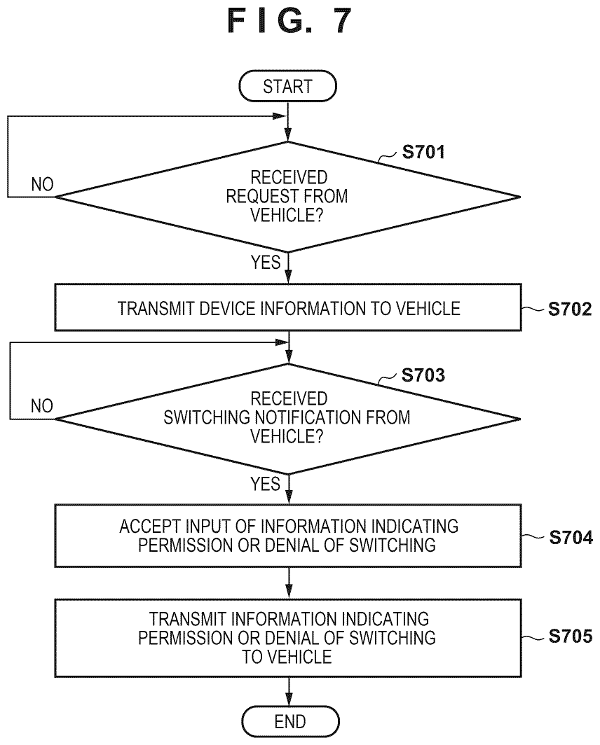

Next, a procedure of processing performed by the communication device according to the present embodiment will be described with reference to a flowchart of FIG. 7. In step S701, the control unit 601 determines whether the reception unit 603 has received a request transmitted from the vehicle V, in a case of detecting in the vehicle V that the first communication using the first communication scheme used by the vehicle V is in a predetermined communication state. Such a request is the acquisition request for acquiring the device information of the communication device 50. In a case where the determination in this step is Yes, the processing proceeds to S702. On the other hand, in a case where the determination in this step is No, the processing waits.

In S702, the device information transmission unit 602 transmits the device information of the communication device 50 to the vehicle V. In step S703, the control unit 601 determines whether the reception unit 603 has received, from the vehicle V, the notification indicating switching from the first communication using the first communication scheme used by the vehicle V to the second communication using the second communication scheme via the communication device 50. In a case where the determination in this step is Yes, the processing proceeds to S704. On the other hand, in a case where the determination in this step is No, the processing waits. However, in a case where it is not received even after a predetermined time elapses, the processing may end. In S704, the acceptance unit 604 accepts an input of information indicating the permission or denial of switching. In S705, the permission or denial information transmission unit 605 transmits, to the vehicle V, the information indicating permission or denial that has been accepted by the acceptance unit 604.

As described heretofore, in the present embodiment, before switching from the first communication to the second communication via the communication device, an inquiry about permission or denial of switching is made to the user of the communication device. In a case where switching is permitted in accordance with its response, switching is conducted.

Accordingly, it becomes possible to prevent the communication from forcibly shifting to the second communication (the tethering communication) in a case where the user of the communication device does not like to consume the communication capacity of the user's own communication device. Therefore, switching control in which user's intention is reflected is achievable.

### Modifications

In the above-described embodiment, the description has been made with regard to an example of giving the notification using the display device 5a. However, the vehicle V may include a plurality of display devices 5a, each of which corresponds to each seat. In such a case, the notification unit 210 may give the notification using the display device 5a, which corresponds to the seat on which the owner of the communication device is seated. For example, an image of an occupant is captured with use of the in-vehicle camera 9a, and the captured image is analyzed to recognize the occupant seated on each seat. Then, person information of the occupant is searched for from person information registered beforehand in the control device CNT, based on the device information (the owner information) of the communication device possessed by the occupant. In a case where a corresponding person is found, it is possible to recognize on which seat the occupant is seated. In such a case, it is possible to give the notification using the display device 5a, which corresponds to the seat on which the owner of the communication device is seated.

In addition, in the above-described embodiment, the description has been made with regard to a case where the device information includes the owner information of the communication device as an example, but there is no limitation to this example. The device information may further include communication cost information of the communication device. In such a case, the notification unit 210 may give the notification, in a case of recognizing that an additional cost is incurred in performing the second communication, based on the communication cost information.

Further, in the above-described embodiment, the description has been made with regard to a case where the device information acquisition unit 204 acquires the device information of one communication device as an example, but there is no limitation to this example. There is a possibility that a plurality of users who respectively possess a plurality of communication devices are present inside the vehicle V or in the surroundings of the vehicle V. In such a case, the device information acquisition unit 204 may acquire the device information from each of the plurality of communication devices. Then, in a case where a plurality of pieces of device information are acquired, the determination unit 205 may determine whether to switch from the first communication to the second communication via one of the plurality of communication devices, based on the device information of the plurality of communication devices. Any communication device may be selected as one of the plurality of communication devices.

Alternatively, as one of the plurality of communication devices, a communication device, the owner of which is identical to the owner of the vehicle V, may be selected first, and whether to switch via such a communication device may be determined. Then, in a case where it is determined not to switch to the second communication via the communication device, the owner of which is identical to the owner of the vehicle V, the determination unit 205 may be configured to determine next whether to switch from the first communication to the second communication via the communication device, the owner of which is not identical to the owner of the vehicle V. In this manner, at first, the determination of switching to the second communication (the tethering communication) via the communication device of the driver who is the owner of the vehicle V is prioritized. Subsequently, it is possible to make the determination of switching to the second communication (the tethering communication) via a communication device other than the driver's (for example, a smartphone possessed by a driver's friend). Therefore, it becomes possible to determine the possibility of permitting the use of the communication device for switching to the second communication in priority of the person.

In addition, in the above-described embodiment, the description has been made with regard to an example in which in a case where the communication state of the first communication (the cellular communication) used by the vehicle V degrades, the first communication is switched to the second communication (the tethering communication) via the communication device, but there is no limitation to this example. For example, in a case where the route guidance to a destination is provided while the vehicle V is traveling, it may be estimated whether the communication state of the first communication (the cellular communication) used by the vehicle V will degrade (fall below a predetermined standard) for equal to or longer than a predetermined time or for equal to or longer than a predetermined distance on the route.

Then, in a case where it is estimated that the communication state will degrade for equal to or longer than the predetermined time or for equal to or longer than the predetermined distance on the route, whether to switch from the first communication to the second communication (the tethering communication) via the communication device may be determined. In this case, it may be estimated by referring to the communication intensity information, which is stored in the storage unit 207, and in which the communication intensity of every access point and the area are associated with each other. Then, if switching is conducted and the communication state on the route will degrade for shorter than the predetermined time or for shorter than the predetermined distance, switching may be determined. That is, switching may be determined, in a case where the communication state is estimated to be improved more than before switching. Alternatively, in a case where a route is continuously outside the communication range of the communication carrier used by the vehicle, when the vehicle V reaches such a route, control may be conducted to switch to the tethering communication using the communication carrier of the communication device.

In addition, in a case where there are a plurality of communication devices inside the vehicle V or in the surroundings of the vehicle V, a communication device using a communication carrier having the highest radio wave intensity may be selected to be switched to.

### Summary of Embodiments

1. The control device according to the above embodiments is a control device (CVT) mounted on a vehicle (V), the control device comprising:
a communication unit (202) configured to perform either first communication using a first communication scheme or second communication using a second communication scheme, the second communication scheme being different from the first communication scheme;
a detection unit (203) configured to detect a communication state of the first communication;
an acquisition unit (204) configured to acquire device information of a communication device present either in an inside of the vehicle or in surroundings of the vehicle; and
a determination unit (205) configured to determine whether to switch from the first communication to the second communication via the communication device, based on the device information, in a case where the detection unit detects that the first communication is in a first communication state while the first communication is being performed.

In this manner, for example, even though the communication state with an external access point used by the vehicle degrades, degradation of the communication state in the vehicle can be reduced by switching to the communication (the tethering communication) via the communication device (the smartphone), based on the device information.

2. The control device (CNT) according to the above embodiments, wherein the acquisition unit acquires the device information, in a case where the detection unit detects that the first communication is in the first communication state while the first communication is being performed.

In this manner, for example, by acquiring the device information of the communication device only in a case where the communication state of the vehicle degrades, unnecessary communication between the vehicle and the communication device can be reduced.

3. The control device (CNT) according to the above embodiments, wherein
the device information includes information indicating a communication state of the communication device, and
the determination unit determines switching from the first communication to the second communication, in a case where the communication device is in a second communication state.

In this manner, for example, in a case where the communication state of the communication device is good, the communication is switched from the communication in the first communication scheme with the external access point to the communication with the communication device in the second communication scheme, so that the degradation of the communication state of the vehicle can be reduced.

4. The control device (CNT) according to the above embodiments, wherein
the device information includes information indicating a type of an access point with which the communication device is communicating in the first communication scheme, and
the determination unit determines switching from the first communication to the second communication, in a case where the type is different from a type of an access point with which the control device is communicating in the first communication scheme.

In this manner, for example, in a case where the external access point of a communication destination of the communication device is different in type from the external access point of a communication destination of the vehicle, there is a possibility that the communication state will be improved by switching, so that the degradation of the communication state of the vehicle can be reduced.

5. The control device (CNT) according to the above embodiments, further comprising:
a position information acquisition unit (206) configured to acquire position information of the vehicle; and
a storage unit (207) configured to store communication intensity of every access point in association with an area, as communication intensity information, wherein
the determination unit determines switching from the first communication to the second communication, in a case where the type is different from the type of the access point with which the control device is communicating in the first communication scheme, and in a case where communication intensity of the access point, with which the communication device is communicating in the first communication scheme in an area where the vehicle is located, is equal to or higher than predetermined intensity.

In this manner, since it is possible to switch after grasping that the external access point with which the communication device is communicating is in a good communication state on the communication intensity map, degradation of the communication state of the vehicle can be reduced.

6. The control device (CNT) according to the above embodiments, further comprising an update unit (209) configured to update the communication intensity information stored in the storage unit, based on a detection result of the detection unit.

Accordingly, it becomes possible to maintain the communication intensity information corresponding to the actual situation, so that accuracy can be improved.

7. The control device (CNT) according to the above embodiments, further comprising:
an intensity information acquisition unit (208) configured to acquire the communication intensity information from a server apparatus that manages the communication intensity information; and
an update unit (209) configured to update the communication intensity information stored in the storage unit, based on an acquisition result of the intensity information acquisition unit.

Accordingly, it becomes possible to maintain the communication intensity information corresponding to the actual situation, so that accuracy can be improved. In addition, since the communication intensity information can be maintained and managed by another server apparatus, the processing load of the control device can be reduced.

8. The control device (CNT) according to the above embodiments, further comprising a notification unit (210) configured to give notification indicating switching from the first communication to the second communication, wherein
the device information includes owner information of the communication device, and
the notification unit gives the notification, in a case where an owner of the communication device is different from an owner of the vehicle.

Accordingly, in a case where the owner of the communication device that is a switching destination is different from the owner of the vehicle, there is a possibility that communication is performed against the intention of the owner of the communication device, but an occurrence of such a situation can be prevented.

9. The control device (CNT) according to the above embodiments, wherein the notification unit gives the notification to the communication device.

This enables the owner of the communication device to easily recognize that there is a possibility that its own communication device will be used.

10. The control device (CNT) according to the above embodiments, wherein
the vehicle includes a display unit (5a), and
the notification unit gives the notification using the display unit.

This enables the owner of the communication device who is an occupant of the vehicle to easily recognize that there is a possibility that its own communication device will be used.

11. The control device (CNT) according to the above embodiments, wherein
the vehicle includes a plurality of display units (5a) each corresponding to a respective seat, and
the notification unit gives the notification using a display unit corresponding to a seat on which an owner of the communication device is seated.

This enables the owner of the communication device who is an occupant of the vehicle to more certainly recognize that there is a possibility that its own communication device will be used.

12. The control device (CNT) according to the above embodiments, wherein
the notification unit gives the notification by transmitting, to the communication device, notification information for inquiring about either permission or denial of performing the second communication using the second communication scheme, and
the control device further comprising a switching control unit (211) configured to switch from the first communication to the second communication, in a case of receiving information indicating the permission from the communication device.

This enables the owner of the communication device to easily recognize that there is a possibility that its own communication device will be used. Switching is performed in a case where use permission is obtained, so that control can be conducted in consideration of the intention of the owner of the communication device.

13. The control device (CNT) according to the above embodiments, wherein
the device information includes communication cost information of the communication device, and
the notification unit gives the notification, in a case of recognizing that an additional cost is incurred in performing the second communication, based on the communication cost information.

Accordingly, it becomes possible to suppress incurring of the communication cost before the owner of the communication device knows it.

14. The control device (CNT) according to the above embodiments, wherein in a case where the acquisition unit acquires device information of a plurality of communication devices, the determination unit determines whether to switch from the first communication to the second communication via one of the plurality of communication devices, based on the device information of the plurality of communication devices.

This enables switching to the communication using any of the plurality of communication devices, and thus increases the number of choices, so that the possibility of reducing degradation of the communication state of the vehicle can be increased.

15. The control device (CNT) according to the above embodiments, wherein
the device information includes owner information of the communication device, and
the one of the plurality of communication devices is a communication device, an owner of which is identical to an owner of the vehicle.

Accordingly, since the owner of the communication device to be switched to is identical to the owner of the vehicle, it becomes possible to reduce the possibility of switching against the intention of the owner of the communication device.

16. The control device (CNT) according to the above embodiments, wherein in a case of determining not to switch to the second communication via the communication device, the owner of which is identical to the owner of the vehicle, the determination unit determines whether to switch from the first communication to the second communication via a communication device, an owner of which is different from the owner of the vehicle.

In this manner, by prioritizing a communication device, the owner of which is identical to the owner of the vehicle, it becomes possible to reduce the possibility of switching against the intention of the owner of the communication device.

17. The control device (CNT) according to the above embodiments, further comprising a switching control unit configured to switch from the first communication to the second communication, in a case where the determination unit determines switching from the first communication to the second communication.

This enables reduction in degradation of the communication state in the vehicle.

18. The control device (CNT) according to the above embodiments, wherein
the first communication scheme is a cellular communication scheme, and
the second communication scheme is a tethering communication scheme.

Accordingly, for example, in a case where the communication state of the cellular communication in the vehicle degrades, it becomes possible to switch to the tethering communication via the communication device, so that degradation of the communication state can be reduced.

19. The communication device according to the above embodiments is a communication device (50) that communicates with a vehicle (V), the communication device comprising:
a device information transmission unit (602) configured to transmit device information of the communication device to the vehicle in response to a request transmitted from the vehicle, in a case where first communication using a first communication scheme used by the vehicle being in a predetermined communication state is detected in the vehicle;
a reception unit (603) configured to receive, from the vehicle, notification indicating switching from the first communication to second communication using a second communication scheme via the communication device, in a case where switching from the first communication to the second communication is determined in the vehicle, based on the device information;
an acceptance unit (604) configured to accept an input of information indicating either permission or denial of switching in response to the notification; and
a permission or denial information transmission unit (605) configured to transmit, to the vehicle, information indicating either the permission or the denial accepted by the acceptance unit.

This enables the owner of the communication device to easily recognize that there is a possibility that its own communication device will be used. Switching is performed in a case where use permission is obtained, so that control can be conducted in consideration of the intention of the owner of the communication device.

20. The communication system according to the above embodiments is a communication system comprising: a vehicle; and a communication device that communicates with the vehicle, wherein
the vehicle includes:
   a request unit configured to transmit a request for acquiring device information of the communication device, in a case where first communication using a first communication scheme used by the vehicle being in a predetermined communication state is detected;
   a determination unit configured to determine whether to switch from the first communication to second communication using a second communication scheme via the communication device, based on the device information; and
   a notification unit configured to give notification indicating switching from the first communication to the second communication, in a case where the determination unit determines switching, and
the communication device includes:
   a device information transmission unit configured to transmit the device information to the vehicle in response to the request;
   an acceptance unit configured to accept an input of information indicating either permission or denial of switching in response to the notification; and
   a permission or denial information transmission unit configured to transmit, to the vehicle, information indicating either the permission or the denial accepted by the acceptance unit.

This enables the owner of the communication device to easily recognize that there is a possibility that its own communication device will be used. Switching is performed in a case where use permission is obtained, so that control can be conducted in consideration of the intention of the owner of the communication device.

21. The operation method of a control device according to the above embodiments is an operation method of a control device (CNT), the operation method comprising:
performing either first communication using a first communication scheme or second communication using a second communication scheme, the second communication scheme being different from the first communication scheme;
detecting a communication state of the first communication;
acquiring device information of a communication device present either in an inside of a vehicle or in surroundings of the vehicle; and
determining whether to switch from the first communication to the second communication via the communication device, based on the device information, in a case where the detecting detects that the first communication is in a first communication state while the first communication is being performed.

In this manner, for example, even though the communication state with an external access point used by the vehicle degrades, degradation of the communication state in the vehicle can be reduced by switching to the communication (the tethering communication) via the communication device (the smartphone), based on the device information.

22. The operation method of a communication device according to the above embodiments is an operation method of a communication device (50) that communicates with a vehicle, the operation method comprising:
transmitting device information of the communication device to the vehicle in response to a request transmitted from the vehicle, in a case where first communication using a first communication scheme used by the vehicle being in a predetermined communication state is detected in the vehicle;
receiving, from the vehicle, notification indicating switching from the first communication to second communication using a second communication scheme via the communication device, in a case where switching from the first communication to the second communication is determined in the vehicle, based on the device information;
accepting an input of information indicating either permission or denial of switching in response to the notification; and
transmitting, to the vehicle, information indicating either the permission or the denial accepted by the accepting.

This enables the owner of the communication device to easily recognize that there is a possibility that its own communication device will be used. Switching is performed in a case where use permission is obtained, so that control can be conducted in consideration of the intention of the owner of the communication device.

23. A program according to the above embodiments is a program for causing a computer to execute the operation method according to the above embodiment.

This enables processing of the operation method to be achieved by a computer.

24. A storage medium according to the above embodiments is a storage medium storing a program for causing a computer to execute the operation method according to the above embodiment.

This enables processing of the operation method to be achieved by a storage medium.

According to the present invention, a good vehicle communication environment is achievable.

### Other Embodiments

In addition, a program for achieving one or more functions that have been described in each embodiment is supplied to a system or an apparatus through a network or via a storage medium, and one or more processors on a computer of the system or the apparatus are capable of reading and executing the program. The present invention is also achievable in such an aspect.

The invention is not limited to the foregoing embodiments, and various variations/changes are possible within the spirit of the invention.

What is claimed is:

1. A control device mounted on a vehicle, the control device comprising:
a communication unit configured to perform either first communication using a first communication scheme or second communication using a second communication scheme, the second communication scheme being different from the first communication scheme;
a detection unit configured to detect a communication state of the first communication;
an acquisition unit configured to acquire device information of a communication device present either in an inside of the vehicle or in surroundings of the vehicle; and
a determination unit configured to determine whether to switch from the first communication to the second communication via the communication device, based on the device information, in a case where the detection unit detects that the first communication is in a first communication state while the first communication is being performed.

2. The control device according to claim 1, wherein the acquisition unit acquires the device information, in a case where the detection unit detects that the first communication is in the first communication state while the first communication is being performed.

3. The control device according to claim 1, wherein
the device information includes information indicating a communication state of the communication device, and
the determination unit determines switching from the first communication to the second communication, in a case where the communication device is in a second communication state.

4. The control device according to claim 1, wherein
the device information includes information indicating a type of an access point with which the communication device is communicating in the first communication scheme, and
the determination unit determines switching from the first communication to the second communication, in a case where the type is different from a type of an access point with which the control device is communicating in the first communication scheme.

5. The control device according to claim 4, further comprising:
a position information acquisition unit configured to acquire position information of the vehicle; and
a storage unit configured to store communication intensity of every access point in association with an area, as communication intensity information, wherein
the determination unit determines switching from the first communication to the second communication, in a case where the type is different from the type of the access point with which the control device is communicating in the first communication scheme, and in a case where communication intensity of the access point, with which the communication device is communicating in the first communication scheme in an area where the vehicle is located, is equal to or higher than predetermined intensity.

6. The control device according to claim 5, further comprising an update unit configured to update the communication intensity information stored in the storage unit, based on a detection result of the detection unit.

7. The control device according to claim 5, further comprising:
an intensity information acquisition unit configured to acquire the communication intensity information from a server apparatus that manages the communication intensity information; and
an update unit configured to update the communication intensity information stored in the storage unit, based on an acquisition result of the intensity information acquisition unit.

8. The control device according to claim 1, further comprising a notification unit configured to give notification indicating switching from the first communication to the second communication, wherein
the device information includes owner information of the communication device, and
the notification unit gives the notification, in a case where an owner of the communication device is different from an owner of the vehicle.

9. The control device according to claim 8, wherein the notification unit gives the notification to the communication device.

10. The control device according to claim 8, wherein
the vehicle includes a display unit, and
the notification unit gives the notification using the display unit.

11. The control device according to claim 8, wherein
the vehicle includes a plurality of display units each corresponding to a respective seat, and
the notification unit gives the notification using a display unit corresponding to a seat on which an owner of the communication device is seated.

12. The control device according to claim 8, wherein
the notification unit gives the notification by transmitting, to the communication device, notification information for inquiring about either permission or denial of performing the second communication using the second communication scheme, and
the control device further comprising a switching control unit configured to switch from the first communication to the second communication, in a case of receiving information indicating the permission from the communication device.

13. The control device according to claim 8, wherein
the device information includes communication cost information of the communication device, and
the notification unit gives the notification, in a case of recognizing that an additional cost is incurred in performing the second communication, based on the communication cost information.

14. The control device according to claim 1, wherein in a case where the acquisition unit acquires device information of a plurality of communication devices, the determination unit determines whether to switch from the first communication to the second communication via one of the plurality of communication devices, based on the device information of the plurality of communication devices.

15. The control device according to claim 14, wherein
the device information includes owner information of the communication device, and
the one of the plurality of communication devices is a communication device, an owner of which is identical to an owner of the vehicle.

16. The control device according to claim 15, wherein in a case of determining not to switch to the second communication via the communication device, the owner of which is identical to the owner of the vehicle, the determination unit determines whether to switch from the first communication to the second communication via a communication device, an owner of which is different from the owner of the vehicle.

17. The control device according to claim 1, further comprising a switching control unit configured to switch from the first communication to the second communication, in a case where the determination unit determines switching from the first communication to the second communication.

18. The control device according to claim 1, wherein
the first communication scheme is a cellular communication scheme, and
the second communication scheme is a tethering communication scheme.

19. A communication device that communicates with a vehicle, the communication device comprising:
a device information transmission unit configured to transmit device information of the communication device to the vehicle in response to a request transmitted from the vehicle, in a case where first communication using a first communication scheme used by the vehicle being in a predetermined communication state is detected in the vehicle;
a reception unit configured to receive, from the vehicle, notification indicating switching from the first communication to second communication using a second communication scheme via the communication device, in a case where switching from the first communication to the second communication is determined in the vehicle, based on the device information;
an acceptance unit configured to accept an input of information indicating either permission or denial of switching in response to the notification; and
a permission or denial information transmission unit configured to transmit, to the vehicle, information indicating either the permission or the denial accepted by the acceptance unit.

20. A communication system comprising: a vehicle; and a communication device that communicates with the vehicle, wherein
the vehicle includes:
a request unit configured to transmit a request for acquiring device information of the communication device, in a case where first communication using a first communication scheme used by the vehicle being in a predetermined communication state is detected;
a determination unit configured to determine whether to switch from the first communication to second communication using a second communication scheme via the communication device, based on the device information; and
a notification unit configured to give notification indicating switching from the first communication to the second communication, in a case where the determination unit determines switching, and
the communication device includes:
a device information transmission unit configured to transmit the device information to the vehicle in response to the request;
an acceptance unit configured to accept an input of information indicating either permission or denial of switching in response to the notification; and
a permission or denial information transmission unit configured to transmit, to the vehicle, information indicating either the permission or the denial accepted by the acceptance unit.

21. An operation method of a control device, the operation method comprising:
performing either first communication using a first communication scheme or second communication using a second communication scheme, the second communication scheme being different from the first communication scheme;
detecting a communication state of the first communication;
acquiring device information of a communication device present either in an inside of a vehicle or in surroundings of the vehicle; and
determining whether to switch from the first communication to the second communication via the communication device, based on the device information, in a case where the detecting detects that the first communication is in a first communication state while the first communication is being performed.

22. An operation method of a communication device that communicates with a vehicle, the operation method comprising:
transmitting device information of the communication device to the vehicle in response to a request transmitted from the vehicle, in a case where first communication using a first communication scheme used by the vehicle being in a predetermined communication state is detected in the vehicle;
receiving, from the vehicle, notification indicating switching from the first communication to second communication using a second communication scheme via the communication device, in a case where switching from the first communication to the second communication is determined in the vehicle, based on the device information;
accepting an input of information indicating either permission or denial of switching in response to the notification; and
transmitting, to the vehicle, information indicating either the permission or the denial accepted by the accepting.

23. A non-transitory computer-readable storage medium storing a program for causing a computer to execute the operation method of claim 21.

24. A non-transitory computer-readable storage medium storing a program for causing a computer to execute the operation method of claim 22.
